(19) United States
(12) Patent Application Publication
(10) Pub. No.: US 2010/0021144 A1
(43) Pub. Date: Jan. 28, 2010

(54) My baby's own theater

(76) Inventor: Ilea Zamira, Fairbanks, AK (US)

Correspondence Address: Ilea Z. Girald, #1033 27th Ave., Fairbanks, AK, 99701, US

(21) Appl. No.: 12/459,608

(22) Filed: Jul. 6, 2009

Related U.S. Application Data
(60) Provisional application No. 61/083,251, filed on Jul. 24, 2008.

(51) Int. Cl. H04N 5/85

(52) U.S. Cl. 386/126; 386/E05.064

(57) ABSTRACT

A portable DVD player wich is adapted for securely supporting within an interior of a baby's crib or on a flat surfaces, wich is arranged for a regeargeble battery from the output adapter, wich is arranged for electrically extending from a power source.

### BACKGROUND OF THE INVENTION

1. Field of the Invention

The present invention relates generally to a portable DVD player technology and the processing of video images and, more. This portable DVD player is capable of installing into a baby's crib and on flat surfaces.

2. Description of the Related Art

There is a few different types of portable DVD players for kids but not one specially for placing inside a baby's cribs. Due to the limited space of the baby's crib the equipment will have on the back two straps that will help to place the equipment on a right and safe place for the child. The portable DVD player can be place on any sides of the baby's crib. Furthermore, when the portable DVD player is broken, the user must replace the whole system. Such as the portable DVD player is specifically designed for a baby's crib and flat surfaces so that once the portable DVD player is placed inside the baby's crib it would be manageable to move to an flat surface.

It is desirable to have an equipment that provides an excellent video images and audio while minimizing cost and eliminating the need for large and expensive toys that the baby will get bored soon.

### SUMMARY OF THE INVENTION

A main object of the present invention is to provide a portable DVD player which is capable of installing inside a baby's crib and placed on flat surfaces such that the portable DVD player can be detachably.

Another object of the present invention is to provide a portable DVD player that it would not be expensive or complicated structure is required to employ in the present invention. The present invention successfully provides an economic and efficient solution for installing the portable DVD player inside a baby's crib or on flat surfaces.

It should be appreciated that the present invention can be implemented in numerous ways as several described below.

The portable DVD player would have a sensor on front of the equipment for the remote control so it would be more easily to manage the equipment. Therefore, the equipment will can be easily connected to the power source to the outlet, living all kinds of wires outside the crib for security purpose.

This portable DVD player will have a cloud style all around the equipment living behind all buttons of commands and wires.

Another object of the present invention is the portable DVD player will have a rechargeable battery. These and other objective, features, and advantages of the present invention will become apparent from the following detailed description, the accompanying drawings, and the appended claims.

### BRIEF DESCRIPTION OF THE DRAWINGS

The present invention will be readily understood by the following detailed description in conjunction with the accompanying drawings.

FIG. 1A—Illustrate a perspective of view of the front of the portable DVD player that can be placed inside a baby's crib or on flat surfaces.

FIG. 2A—Is a perspective of view of the back of the portable DVD player.

FIGS. 3A and 3B—Are a perspective of view of the left and right sides of the portable DVD player showing al buttons of command.

FIG. 4A—Is a perspective of view of the remote control device of the portable DVD player.

### DETAILED DESCRIPTION OF THE PREFERRED EMBODIMENTS

In the following description, numerous specific details are set forth in order to provide a thorough understanding of the present invention. It will be understood, however, to one skilled in the art, that the present invention may be practiced without some or all of these specific details. In other instance, well known process operations have not been described in detail in order not unnecessarily obscure the present invention.

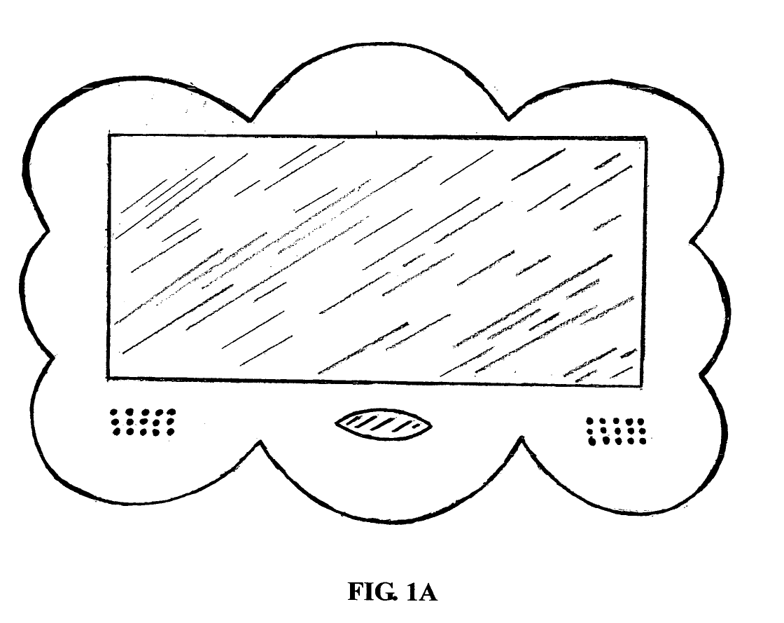

FIG. 1A—Is the front view illustrating a portable DVD player in accordance with one embodiment of the present invention. The portable DVD player includes an LCD, arrangement with two audio speakers, on each sides of the portable DVD player, one on the lower right and another on the lower left. On the lower middle of the equipment shows the remote control sensor. The architecture of the portable DVD player has been design as a cloud style which is bigger than the back of the equipment for security purpose, this way the infant or child won't have access to the buttons of commands. The devise arrangement comprises a portable DVD player which is adapted for securely supporting within interior of a baby's crib or adapted to be detachably mounted on a flat surfaces. The cloud style around the portable DVD player can have different colors and it would have a great size for place inside a baby's crib and the unique style of the cloud that gives and excellent touch to a baby's crib.

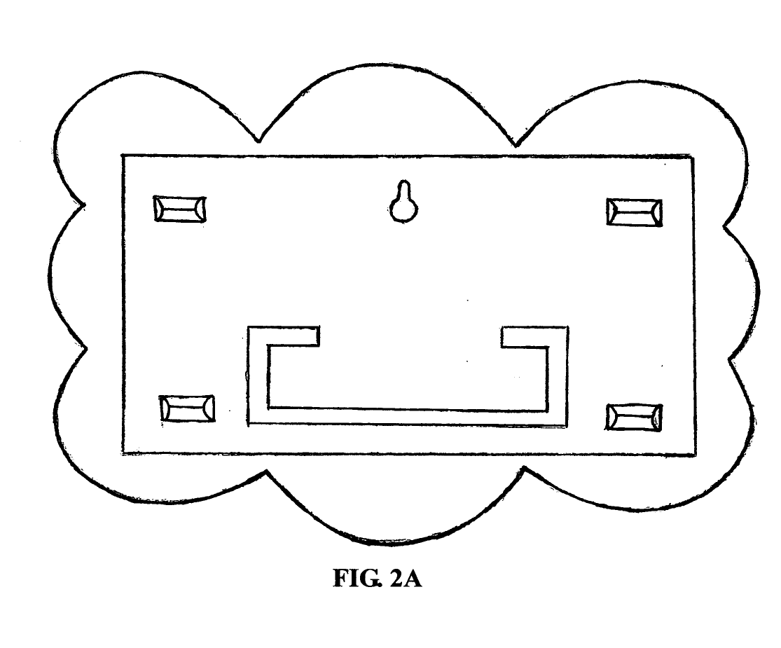

FIG. 2A—Is the back view illustrating on the lower back the stand for placing the portable DVD player on any flat surfaces. It shows on the back of the equipment that on the right side and left side are the spaces to placed the straps, this are for securely adjust the equipment to a baby's crib. It shows that the back is smaller that the front of the equipment for security purpose as shown in FIG 1A. This illustration show how to placed the equipment inside the baby's crib by securely adjust the two straps on both sides of the portable DVD player, but the idea can be extended to other type of use, on flat surfaces.

The present invention is ideally suited to the parents who will have an excellent tool to aid in the development of the infant's vision, hearing and brain functions. This portable DVD player can be even be utilized as a wall flat television, is like infant or child have his own home theater. On the upper middle of the back of the equipment is located the specially design space for placing the portable DVD player on the wall. The battery pack is preferably a rechargeable for high power density at low cost.

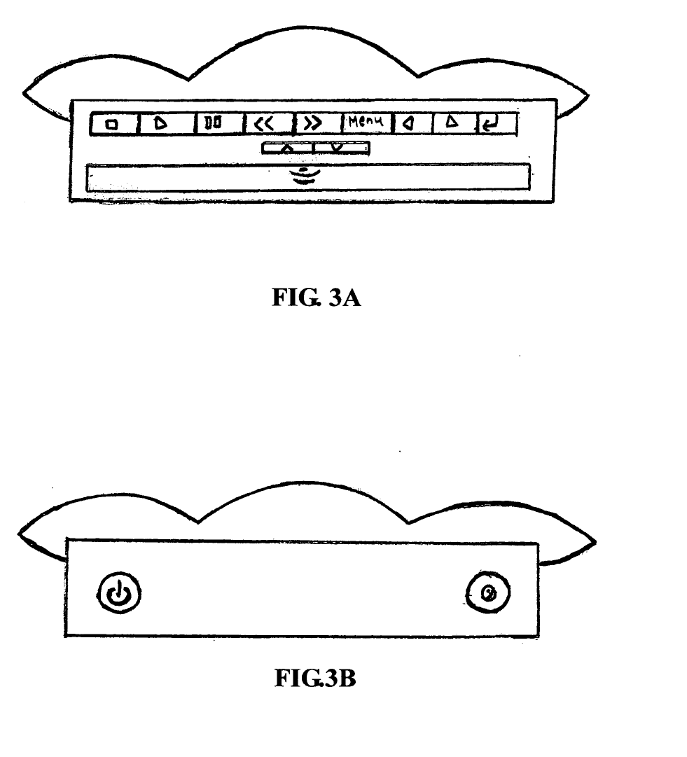

FIG. 3A—Is the left side view illustrating of the portable DVD player showing most of the buttons of commands for the portable DVD player. The rewind, forward, stop, play, pause, menu, left arrow, right arrow, enter and for the audio they are two buttons one for turn it up the volume and another to turn down the volume. On this right side of the portable DVD player will be the DVD and CD drive, you will need to push in and release to open the DVD and CD drive.

This is a convenient and secure way to insert a DVD or CD to the portable DVD player. The DVD and CD drive will be located below the buttons of commands. All the buttons are substance to change of place until a professional in technology evaluate the equipment. On this left side of the portable DVD player it shows that the design of the cloud shown on FIG. 1A is larger than the borders of the equipment, this are for security purpose. Once the equipment is securely place inside the baby's crib the infant or child won't have access to the buttons of commands.

FIG. 3B—Is the right side view illustrating a portable DVD player. On this side of the portable DVD player is located on the left side the power switch and on the left side is located the AC power adapter, this are for the power of the portable DVD player and the other is for the connect the power cord for recharge the battery as shown on the drawing 3B. On this right side it shows that the cloud design is larger than the borders of the equipment, this is for security purpose, as shown on FIG. 1A. These commands are substance to change of place until a professional in technology evaluate the equipment.

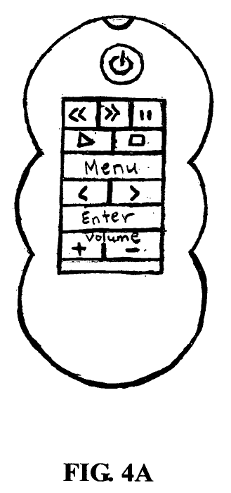

FIG. 4A—Is the remote control device for the portable DVD player. Showing all buttons of commands. This is a great device to have an easily manage of the portable DVD player. With this remote control it would do all commands for the portable DVD player, it can turn on or off the equipment, rewind or forward, stop, turn up and turn down the volume buttons, the menu button, up and down arrows for the functions of the enter button.

All the commands for the portable DVD are on the remote control. This will be the best part of the equipment, more comfortable for parent to manage the equipment from the distant and don't have to batter the infant or baby at the moment the portable DVD player is on use. The remote control as shown of FIG. 4A it have a cloud style, this will be handling and get the baby touch for the equipment. The sensor for the remote control is located at the lower middle of the front of the portable DVD player as shown on FIG 1A. One skilled in the art will understand that the embodiment of the present invention as shown in the drawings and described above is exemplary only and not intended to be limiting. It embodiments have been shown and described for the purposes of illustration the functional and structural principles of the present invention and is substance to change.

A statement that the substitute specification contains no new matter.

What is claimed is:

1. A provisional patent was filed for this invention on Jul. 24, 2008. Application number 610-832-51. The ornamental design for a portable DVD player, as shown and described.
